(19) United States
(12) Patent Application Publication
(10) Pub. No.: US 2019/0081440 A1
(43) Pub. Date: Mar. 14, 2019

(54) Securing Device

(71) Applicants: Michael W. Winders, Baxter, IA (US); Joel Douglas, Newton, IA (US); James Braunschweig, Mitchellville, IA (US); Daryl Michael, Newton, IA (US)

(72) Inventors: Michael W. Winders, Baxter, IA (US); Joel Douglas, Newton, IA (US); James Braunschweig, Mitchellville, IA (US); Daryl Michael, Newton, IA (US)

(21) Appl. No.: 15/699,166

(22) Filed: Sep. 8, 2017

(51) Int. Cl. H01R 13/639

(52) U.S. Cl. CPC H01R 13/6395; H01R 24/66

(57) ABSTRACT

The invention provides means to retain and secure the relative positions of an electrical connector and a socket. The relative positions of the connector and socket are releasably retained by a securement which is comprised of a portion of flexible material resiliently biased to a particular configuration. The securement comprises, two leg sections separated by an arcuate portion, each leg section equipped with an opening through which either or both of the connector and the socket will fit. To associate the connector and socket the leg sections are compressed toward each other, the connector inserted through the two openings, its pins inserted into the socket, and the compression released, the bias thereby securing the relationship. To disassociate the connector and socket, compression force is reapplied, and the connector removed. The connector and socket positions may also be reversed in the aforementioned process.

### FIELD

Electrical safety assemblies for providing safe and secure electrical connections, specifically, secured connections between prongs and sockets for allowing transmission of electrical power through associated machines and conduits.

### DESCRIPTION OF THE PRIOR ART

Electricity kills or injures a number of people each year. Additionally, incorrectly connected sockets and plugs may result in fires or electric shock at home or in the workplace. Further, interruption of the flow of electricity in an industrial setting where it is employed to power various machines perhaps set in series to accomplish a stepwise process can be costly in both time and quality of a product or service, not to mention dangerous where step-wise processes may be interrupted without notice.

The standard arrangement to transmit power from a power source to a machine or other entity needing electrical power to operate typically includes an insulated cord through which the electrical power will travel through a conductive conduit e.g. wire. The typical cord has two ends one which delivers the power to the machine or other entity, the other end receives power from the power source. We most often think of the end that receives the power from, for example, an outlet in a wall as a “connector” with the other end comprising a socket into which another connector will fit to further transmit power, or the other end may be permanently or removably attached to a machine or apparatus thereby directly delivering power through the conduit to that machine or apparatus. However, a connector may also be used to deliver power and a socket can be used to receive electrical power. In short, so long as the power has an adequate conduit along which to travel and means that allow that power to travel from source to the machine or apparatus, it will be delivered so long as the connection is made.

U.S. Pat. No. 7,320,613 claims a female locking electrical outlet and discloses and claims a complex arrangement for securing the socket and connector, employing a button for release and receptacles, locking tabs, and locking members. These engage the prongs of the connector. Another patent claims a socket having a housing. Within the housing is a lock mechanism having a restraint; the restraint is biased to secure the prongs of the connector in the female socket. A button extending outside the housing is pushed, which actuates the restraint to release pressure from the prongs and allow removal.

U.S. Pat. No. 8,439,697 discloses a friction-fit mechanism and claims a spring-biased locking mechanism having an actuation portion and a linking portion to link the actuation portion with the locking mechanism, all within the housing and is integral to the housing.

U.S. Pat. No. 7,744,400 describes means to retain the connector, where the means are not in contact with the prongs on the connector, and are not internal to the housing. Resilient tabs having openings located on the male connector and pegs located on the female socket are described. As the prongs are inserted into the socket, the male connector's tab's opening slides over the peg on the female socket and is secured thereby.

U.S. Pat. No. 8,152,554 discloses a straightforward mechanism for securing a connector in a socket. Here, as the socket and connector are engaged, one of the prongs is inserted through a “clamping mechanism” extending into the socket's housing. The clamping mechanism comprises one leg with a section bent at a right angle, this leg extends into the socket's housing and the bent portion includes an opening through which one prong of the connector is inserted. The other end of the clamping mechanism extends to the outside of the socket's housing. Upon insertion of the prong, the clamping mechanism prevents removal. When the user pushes on the end of the clamping mechanism that extends through the housing, the retaining force is removed and the connector may be removed.

U.S. Pat. No. 6,835,903 provides a locking and releasing structure, but differs in many aspects from the present invention.

U.S. Pat. No. 9,496,648 provides for a friction fit securement which is located internal to the female socket. It covers a socket/connector combination that includes a locked and an unlocked position, accomplished via the sliding motion of an internal block; this movement causes two components within the female socket housing to move closer together against the prongs of the connector (thereby securing the male connector) or to move further apart (allowing the connector to be removed). The slide is moved by the user, using a slide button on the outside of the socket.

And, finally, U.S. Pat. No. 8,956,174 provides a relatively complex mechanism mounting within the housing of the socket. This assembly comprises clips and locking surfaces moveable between a locked and unlocked position, all within the housing and actuated by a push button located outside the housing.

Often interruption in electrical power supply is caused by a complex issue at the source of power. However, interruptions are also often caused by a simple, physical interruption such as an accidental disconnection of an electrical power source from the machine or process requiring power. In addition to the negative effects power interruption can have on efficiency and production, a socket and connector end that are not adequately associated may leave a portion of a prong or other connecting member exposed. Such exposure increases the risks of both fire and shock and may also cause costly or dangerous interruptions in processes where a number of electrically powered mechanisms are serially arranged. Preventing these unplanned disconnections and the unsafe exposure of electrical power and risk of fire and shock is the objective of the present invention.

### SUMMARY OF THE INVENTION

The present invention comprises a securement which is an element separate from both the connector and the socket. The securement is at least partially comprised of a portion of resilient material having an arcuate portion said securement also comprising a first leg and a second leg. The legs may be of similar or equal length. Alternatively, one leg may be longer than the other. The legs may be separate elements that are associated with the arcuate portion or the securement may be of one-piece fabrication and completely comprised of the resilient material. If completely constructed from a single piece of the resilient material, that material may be of generally rectangular shape which is bent to form the arcuate portion. However, a rounded disk or oblong or a square-type shape will also lend itself to be formed into the arcuate portion. Alternatively, a resilient material may be molded or otherwise created as the securement with the arcuate portion. The shape or form, then, of the resilient material (prior to creating the arcuate portion resulting in the first leg and the second leg) is not critical to the invention.

Each of the first leg and the second leg has an opening sized to accommodate a socket and/or connector. The securement is comprised of material having resiliency, thereby urging the first leg and second leg to remain in or return to their respective positions that result from the arcuate portion.

The opening in each leg is positioned such that they can be made generally coaxial or at least adjusted to a position where each of the openings comprises a portion that is coaxial with the other opening when the first and second leg are compressed toward each other, but are not coaxial if the legs are not under compression.

To use the securement, the opening in the second leg is positioned over and above a socket assembly; the opening in the first leg is sized to allow a connector assembly to be inserted therethrough and also through the opening in the second leg to thereafter be coupled with the socket. The resiliency of the securement allows the first leg and second leg of the securement to be compressed towards one another causing the opening in the first leg and the opening in the second leg to become more coaxially aligned. This allows the coupling of the socket assembly and the connector assembly and, upon release of the compression force (after the socket and connector are associated), the first and second legs are urged back toward their relative positions by the resiliency of the material used thereby securing the relative positions of the socket assembly and the connector assembly. Described another way, upon associating the socket and assembly, release of the compression force allows the bias provided by the resilient material of the arcuate portion to urge the legs to return to their respective positions, thereby causing the second leg to apply angular pressure to the female socket assembly, locking it in position.

When the connector assembly and socket assembly need to be disassociated, compression force is reapplied to the first leg of the securement compressing it toward the second leg, thereby causing the openings of the first and second legs to become more aligned which relieves the angular pressure and most, if not all, of the physical contact between the securement and the connector assembly and/or socket. This allows the connector assembly and socket assembly to be disassociated, removing the connector assembly back through the opening in the first leg. This invention operates outside the housing of the socket, and outside the housing of the connector. Optionally, the second leg of the securement may be permanently or removably associated with a surface for added safety and security, or, alternatively neither leg is associated with a surface. The relative orientation of the connector and socket may, instead, mean that the socket assembly is inserted through the opening in the first leg to be coupled with the connector assembly positioned on the other side of the second leg of the securement.

### BRIEF DESCRIPTION OF THE DRAWINGS

FIG. 1 is a perspective view of the securement without compression;

FIG. 2 is a perspective view showing an exploded view of the assembly of the securement and connector assembly;

FIG. 3 is a perspective view showing the assembled securement and connector assembly;

FIG. 4 is a perspective view of the securement compressed and associated with a connector assembly, and, separated therefrom, a socket assembly;

FIG. 5 is a perspective view of the securement compressed and associated with a connector assembly , the connector assembly associated with the socket assembly; and

FIG. 6 is a perspective view of FIG. 5 wherein the securement is not compressed thereby providing bias to secure the relative positions of the connector assembly and the socket assembly.

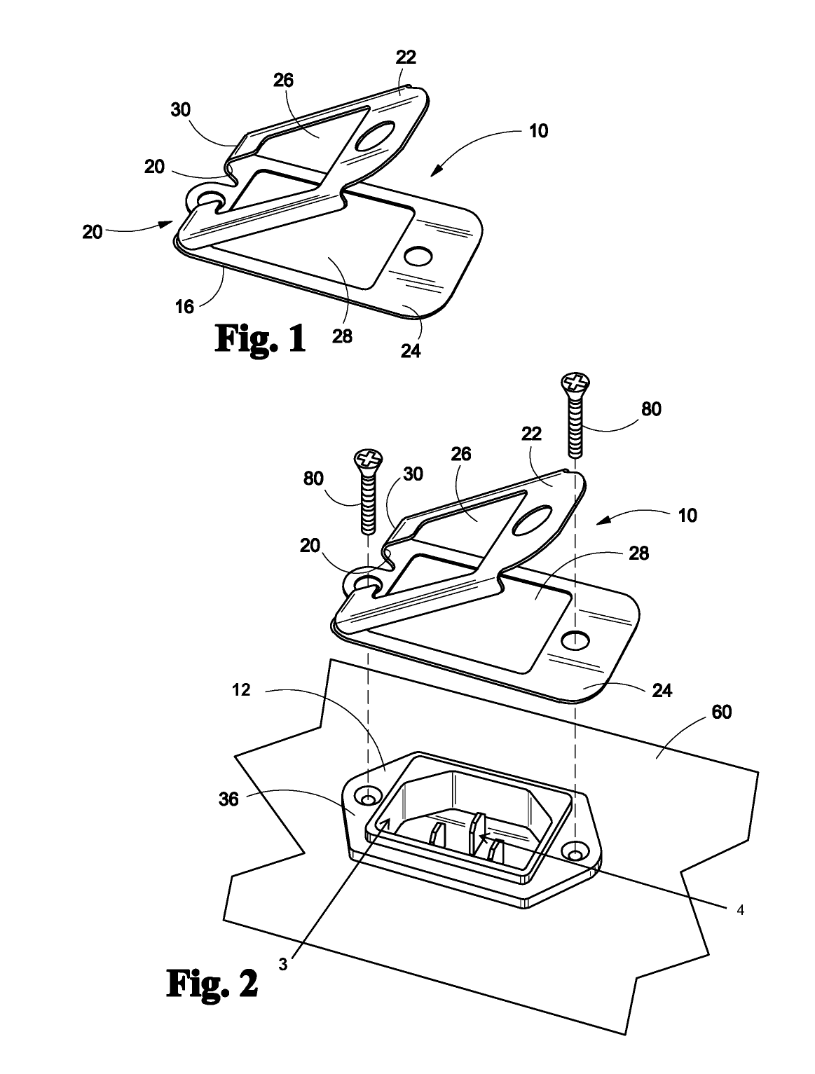

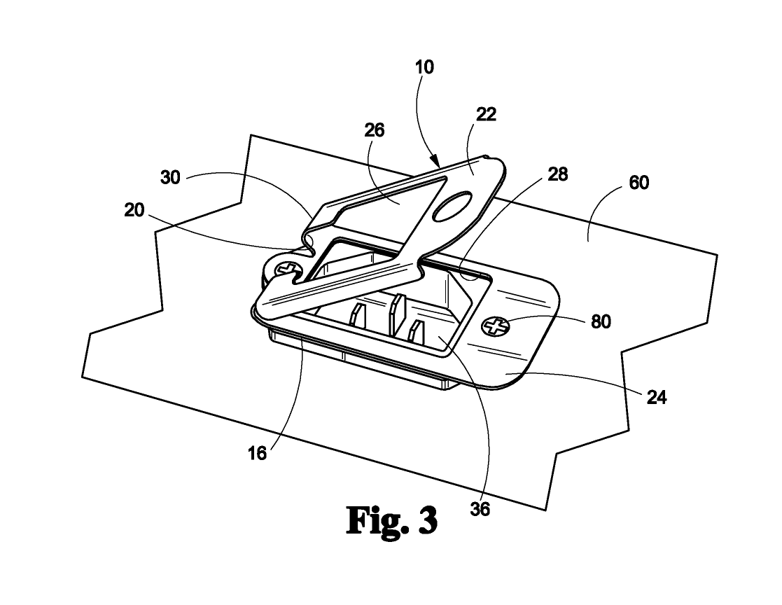

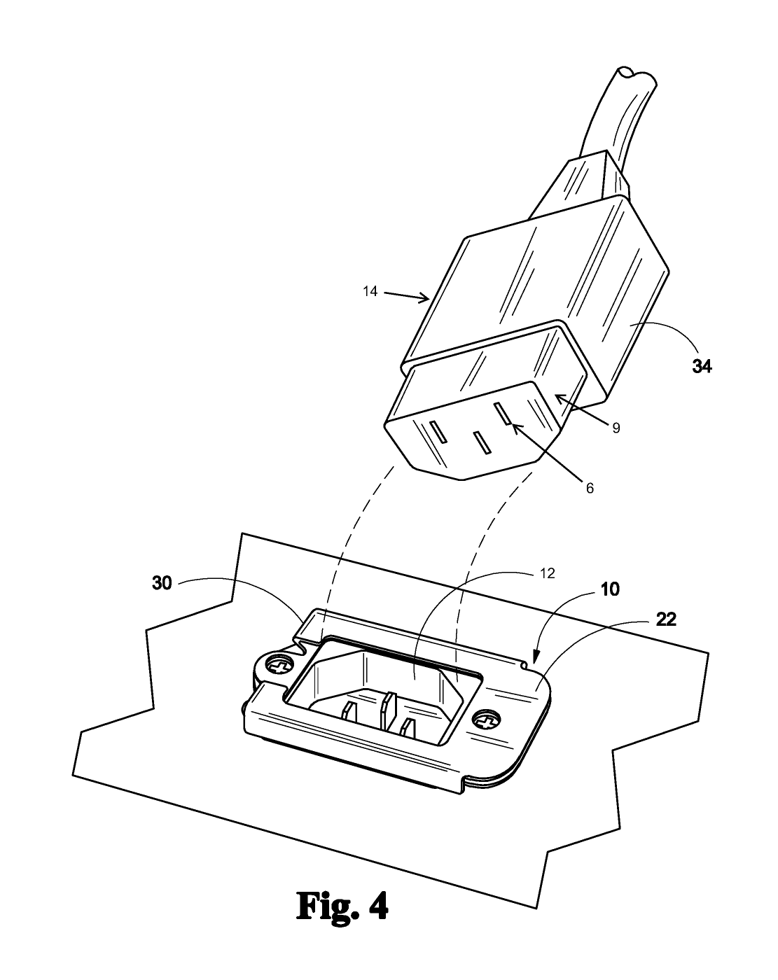

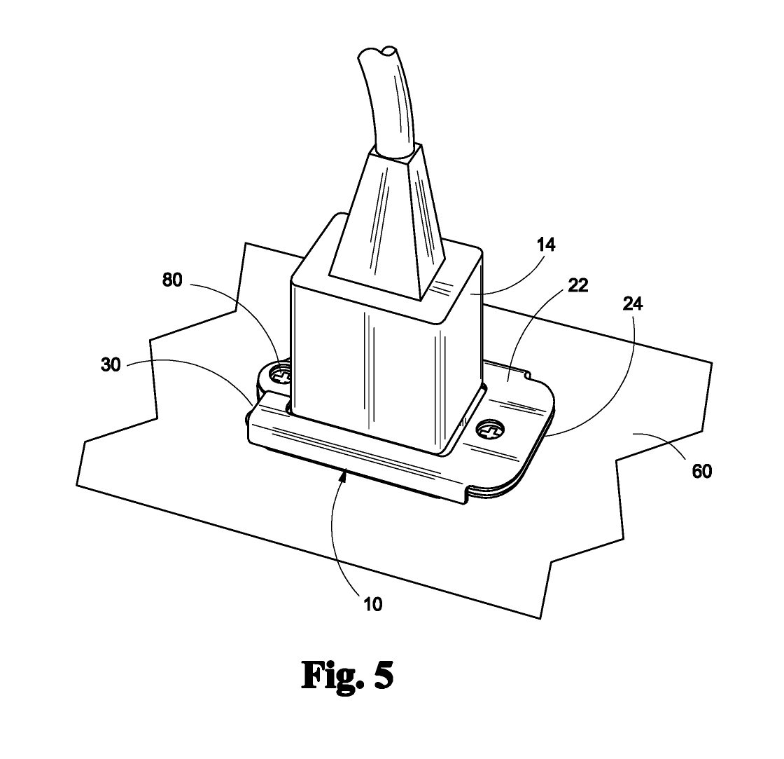

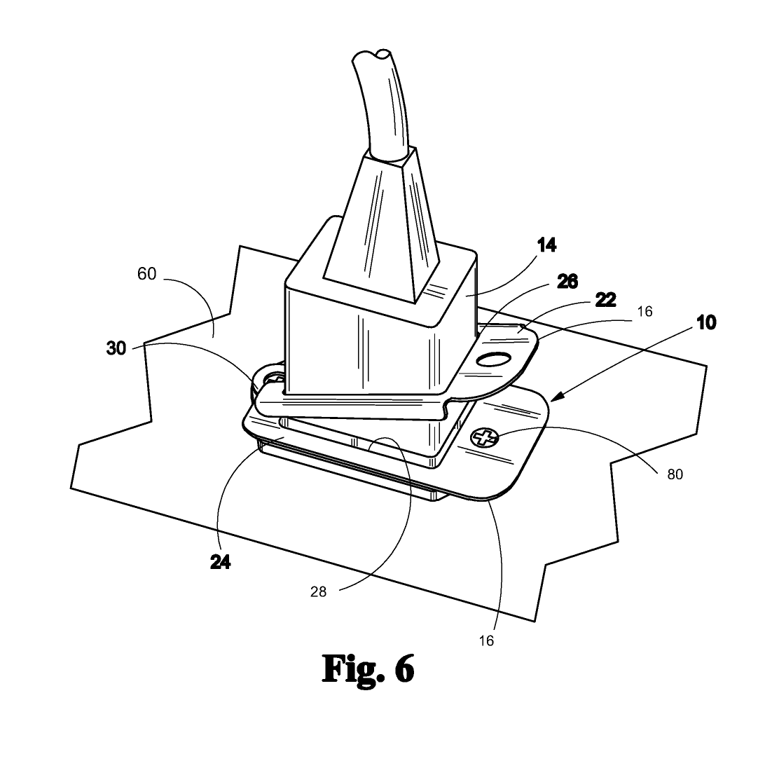

### DETAILED DESCRIPTION OF THE INVENTION

The present invention comprises a securement 10 for detachably securing a connector assembly 12 comprising a connector housing 3 and at least one connector pin 4 and a socket assembly 14 comprising at least one socket opening 6 and, often, comprises a socket plate or socket housing 9. The securement 10 is separate from both the connector assembly 12 and the socket assembly 14. The securement 10 is comprised of a portion of resilient material 2 which may be generally planar but is not required to be planar so long as the resilient material can be manipulated to include an arc 30 in an arcuate section 20 said portion 2 having a perimeter 16, said arcuate section 20 between a first leg 22 and a second leg 24 wherein said leg 22 and leg 24 may comprise the resilient material 2, may be integral with the arcuate section 20, may be separate elements from the arcuate section and associated therewith or may comprise another material. The legs 22 and 24 are not restricted as to shape. Said leg 22 and said leg 24 may be of similar dimensions or may vary greatly from one another.

The resilient material 2 may comprise any resilient metals (e.g., spring steel, certain grades of stainless steel, brass, etc), and any plastics polymer or copolymer (e.g., nylon, Polypropylene, PBT, etc.) or any other material comprising resiliency adequate to provide the appropriate force to urge the legs 22 and 24 back to their positions when the compression force is removed for a purpose to be explained herein.

The securement 10 further comprises at least a first opening 26. The first opening 26 may be located in either the first leg 22 or the second leg 24. Optionally, a second opening 28 may be positioned in one of the first or second legs 22, 24. The second opening 28 is preferably in the leg where the first opening 26 is not positioned. The perimeter 16 of the portion of resilient material 2 may be of any shape. The arcuate section 20 may be positioned anywhere on the portion of resilient material 2 so long as the arc 30 in the resilient material 2 can be adequately compressed by a compression force to facilitate the operation of the securement 10.

The securement 10 may be of single-piece construction consisting of the portion of resilient material 2. In this embodiment, the arcuate section 20 will necessarily result in forming and allowing at least partial alignment of the first leg 22 and the second leg 24 which, in turn, provides means to cause at least partial alignment of openings 26, 28. The first and second legs 22 and 24 may be of similar or equal shape, length, or size. Alternatively, the first leg 22 may be longer than the second leg 24 or vice versa. Prior to the formation of the arcuate section 20, the portion of resilient material 2 may be of generally rectangular shape, however, a rounded disk or oblong or a square-type or other polygonal shapes will also lend themselves to be used in the manner set forth herein. The shape, then, of the portion of resilient material 2 (either prior to creating or after creating the arc 30 resulting in formation of the first leg 22 and the second leg 24) is not critical to the invention.

In an alternate embodiment, the resilient material 2 comprises a plastic or other material that can be formed as the desired shape of the securement. The securement of this embodiment may be molded, 3-D printed or otherwise fabricated. One or both of the first leg 22 and the second leg 24 and the openings 26, 28, respectively, are sized to accommodate a socket assembly 14 and/or a connector assembly 12. The securement 10 is comprised of material 50 having resiliency, thereby urging the first leg 22 and second leg 24 to remain in or return to their respective positions that result from flex and resiliency of the material 50 arc 30 of the arcuate section 20.

To use the securement 10, the opening 28 in the second leg 24 is positioned over and above a connector assembly 12; the opening 26 in the first leg 22 is sized to allow a socket assembly 14 to be inserted therethrough and also through the opening 28 in the second leg 24 to thereafter be coupled with the connector assembly 12. In its non-compressed form the openings 26 and 28 are not fully coaxially aligned. However, the resiliency of the securement 10 allows the first leg 22 and second leg 24 of the securement 10 to be compressed towards one another; upon compression, the openings 26 and 28 become more coaxially aligned, even substantially aligned, and when the alignment provides an opening large enough, the socket assembly 14 and the connector assembly 12 may be coupled therethrough. Upon release of the compression force (after the socket assembly 14 and connector assembly 12 have been and are associated), the first and second legs 22, 24 are urged back toward their relative positions by the resiliency of the material used thereby causing a misalignment of the openings 26 and 28, in turn creating a point of contact and resistance on at least one of the socket assembly 14 and the connector assembly 12 securing their relative positions. Described another way, upon associating the socket assembly 14 and the connector assembly 36, release of the compression force allows the legs 22 and 24 to be biased back toward their respective positions, causing the first leg 22 to apply angular pressure to the socket assembly 14 and the second leg to apply angular pressure to the connector assembly 12, locking the connector assembly 12 and socket assembly 14 in relative position. When the connector assembly 12 and socket assembly 14 need to be disassociated, compression force is reapplied to at least one or both of the first leg 22 and the second leg 24 of the securement 10 compressing the first leg 22 toward the second leg 24, thereby increasing the degree of alignment of openings 26, and 28 and relieving the angular pressure and most, if not all, of the physical contact between the securement 10 and the connector assembly 12 and/or socket assembly 14, allowing the connector assembly 12 and socket assembly 14 to be disassociated, thereafter removing the connector assembly 12 back through the opening 26 in the first segment 22.

In one embodiment, the second leg 24 of the securement 10 is either permanently or removably secured to a surface 60 on which a connector assembly 12 is positioned. The first leg 22 is at a first position without compression. In this embodiment, opening 28 in the second leg 24 is positioned around the connector assembly 12 positioned on the surface 60 and then the second leg 24 of the securement 10 is secured to the surface 60 by known means which may include glue, brackets, screws, etc. Surface 60 may be integral to the socket assembly 14 or to a surface associated with the socket assembly 14. Alternatively, the second leg 24 may be mounted on the connector assembly 12 or the socket assembly 14. Thereafter, the first leg 22 at the first position may be compressed to a second position so that a socket assembly 14 may be inserted through the opening 26 in the first leg 22, said socket assembly 14 then associated with the connector assembly 12. Release of the compression force on the first leg 22 allows the first leg 22 to be biased back toward its first position and creating a point of contact and resistance on at least one of the socket assembly 14 and the connector assembly 12 securing their relative positions. In an alternative embodiment, the socket assembly 14 may be positioned on surface 60, the second leg 24 positioned around the socket assembly 14 and the second leg 24 of the securement 10 secured to the surface 60.

It should be understood that the references to first segment and second segment could be interchangeably used throughout. Further, either the socket assembly can be inserted through the opening 26 of the first segment to join the connector assembly or the connector assembly can be inserted through the opening 26 of the first segment to join the socket assembly. Likewise, either the socket assembly may be associated with the surface 60 or the connector assembly may be associated with the surface 60.

The present invention has been described with sufficient detail. Example embodiments of the invention have been described in an illustrative manner. It is to be understood that the terminology that has been used is intended to be in the nature of words of description rather than of limitation. Many modifications and variations of example embodiments are possible in light of the above teachings. Therefore, within the scope of the appended claims, the present invention may be practiced otherwise than as specifically described.

1. A securement device for securing a connector assembly in a socket assembly wherein said securement device comprises a at least a portion of resilient material, said portion comprising a first generally planar segment, a second generally planar segment, and an arcuate portion there between, forming an acute angle between the first generally planar segment and the second generally planar segment; a first opening in the first generally planar segment, a second opening in the second generally planar segment, wherein an uncompressed, relative position of the first generally planar segment and the second generally planar segment comprises misalignment of the first and second openings adequate to prevent passage of the connector assembly and the socket assembly, and application of a compression force to either of said planar segments produces compressed relative positions of the first generally planar segment and the second generally planar segment comprising a higher degree of alignment of the first and second openings adequate to allow passage of the connector assembly and the socket assembly; upon removal of the compression force the resiliency of the material urges the first and second planar segments toward a return to their uncompressed, relative positions thereby applying to the connector assembly a friction force and a torsion force resulting from the angle between the first and second openings securing the connector assembly and providing a relative increase in torsion force upon application of a relative increase in force urging separation of the connector assembly and the socket assembly.

2. A method of using the securement device of claim 1 comprising compressing the first generally planar segment toward the second generally planar segment to provide adequate alignment of the first opening and the second opening to allow insertion of the connector assembly from the outside of the securement device through the first opening in the first generally planar segment and the second opening in the second generally planar segment, associating the connector assembly with the socket assembly and releasing said compression thereby securing the connector assembly to the socket assembly by friction force resulting from the misalignment of the first and second openings and resultant friction force applied on the connector assembly; upon removal of the compression force the first and second planar segments tend to return to their uncompressed, relative positions thereby applying to the connector assembly a friction force and a torsion force resulting from the angle between the first and second openings securing the connector assembly and providing a relative increase in torsion force upon application of a relative increase in force urging separation of the connector assembly and the socket assembly.

3. The securement device of claim 1 comprising a unitary construction.

4. The securement device of claim 1 comprising a resilient material selected from the group consisting of spring steel, stainless steel, brass, plastics, polymers, copolymers, nylon, Polypropylene, and PBT.

5. The securement device of claim 1 said securing device comprising at least one means to associate the device with a surface of another item.

6. The securement device of claim 5 said means to associate comprising at least one of a slot or a hole.

7. The securement device of claim 6 said slot or hole sized to accommodate at least one selected from a group consisting of a peg, tab, button, raised surface, snap, that is associated with a surface of another item.

8. The method of claim 2 wherein the socket assembly and the connector assembly are separated by re-applying the compression force to negate the bias, and then extracting the socket assembly through the second opening in the second generally planar segment, and then through the first opening in the first generally planar segment.

9. A securement device for securing a connection between a connector assembly and a socket assembly, said device comprising a portion of resilient material comprising an arcuate section, a first generally planar leg extending from said arcuate section having a first opening sized adequately to accommodate insertion there through of at least one of a connector assembly and a socket assembly, and a second generally planar leg extending from the arcuate section having a second opening sized adequately to accommodate insertion there through of at least one of a connector assembly and a socket assembly, wherein under no compression said first opening and said second opening are at least partially misaligned preventing simultaneous insertion through the first opening and the second opening of either one of the connector assembly or the socket assembly and under compression said first opening and said second opening are at least partially aligned providing means to insert either one of the connector assembly or the socket assembly through the first opening and the second opening simultaneously; upon removal of the compression force the first and second planar segments tend to return to their uncompressed, relative positions thereby applying to the connector assembly a friction force and a torsion force resulting from the angle between the first and second openings securing the connector assembly and providing a relative increase in torsion force upon application of a relative increase in force urging separation of the connector assembly and the socket assembly.

10. The securement device of claim 9 wherein the degree of misalignment of the first and second openings depends on the relative position of the first and second generally planar legs, said position adjustable by compression force against the resilient material.

11. A method of using the securement device of claim 9 wherein a compression force is applied to cause the alignment of the first and second openings to allow at least a portion of the connector assembly to be inserted there through and then associated with the socket assembly wherein releasing the compression force secures the association of the connector assembly and the socket assembly.

12. The securement device of claim 9 wherein the device is associated with a surface upon which a socket assembly is affixed.

13. The securement device of claim 12 wherein the first opening of the generally planar first leg of the securement device is positioned around the socket assembly on the surface.

14. A method of using the securement device of claim 13 said method comprising applying a compression force to compress the second generally planar leg toward the first generally planar leg to align the openings, inserting the connector assembly through the openings, thereafter connecting the connector assembly with the socket assembly and removing the compression force thereby securing the connector assembly to the socket assembly.
